(19) United States
(12) Patent Application Publication
(10) Pub. No.: US 2026/0331562 A1
(43) Pub. Date: Oct. 22, 2026

(54) SECONDARY BATTERY

(71) Applicant: TOYOTA JIDOSHA KABUSHIKI KAISHA, Toyota-shi (JP)

(72) Inventors: Yosuke SHIMURA, Nagakute-shi (JP); Suguru IKEYAMA, Toyota-shi (JP); Kazuhito KATO, Toyota-shi (JP); Yasuhiro SAKASHITA, Nisshin-shi (JP); Takahiko NAKANO, Nagoya-shi (JP); Tomofumi HIRUKAWA, Miyoshi-shi (JP)

(73) Assignee: TOYOTA JIDOSHA KABUSHIKI KAISHA, Toyota-shi (JP)

(21) Appl. No.: 19/536,464

(22) Filed: Feb. 11, 2026

(30) Foreign Application Priority Data
Apr. 18, 2025 (JP) 2025-068912

(51) Int. Cl. H01M 10/0525; H01M 10/052; H01M 10/0585

(52) U.S. Cl. CPC H01M 10/0525; H01M 10/052; H01M 10/0585

(57) ABSTRACT

The secondary battery includes an electrode stack in which a plurality of electrodes, each including an electrode active material layer coated on at least one surface of a current collector in the form of a sheet, is stacked in a first direction with a separator interposed between the electrodes. Each of the electrodes includes a current collecting tab that is not coated with the electrode active material layer and that protrudes in a second direction intersecting the first direction. The current collecting tab includes an insulating layer on a surface facing the first direction. The insulating layer includes a protrusion that protrudes toward the separator. The thickness of the insulating layer including the protrusion is smaller than the thickness of the electrode active material layer.

### CROSS-REFERENCE TO RELATED APPLICATION

This application claims priority to Japanese Patent Application No. 2025-068912 filed on Apr. 18, 2025. The disclosure of the above-identified application, including the specification, drawings, and claims, is incorporated by reference herein in its entirety.

### BACKGROUND

### 1. Technical Field

The technology disclosed in the present specification relates to secondary batteries.

### 2. Description of Related Art

Japanese Unexamined Patent Application Publication (Translation of PCT Application) No. 2023-530514 (JP 2023-53514 A) discloses an electrode including a current collector coated with an electrode active material, an electrode tab protruding from the current collector, and an insulating layer coated on the electrode tab. The opposite surface of the electrode tab on which the insulating layer is coated is welded to an electrode lead.

Japanese Unexamined Patent Application Publication No. 2018-45952 (JP 2018-45952 A) discloses a method for manufacturing an electrode having a coated region where an active material layer is formed on a current collector, and an uncoated region where no active material layer is formed. This method includes a step of forming an insulating resin layer such that it extends across the coated portion and the uncoated portion.

### SUMMARY

A secondary battery includes an electrode stack in which electrodes, each including an electrode active material layer coated on a current collector, and separators are alternately stacked. In conventional electrode stacks of this type, relative misalignment occurs between the separator and the electrodes in a direction intersecting the direction in

which the electrodes and the separator are stacked. Neither JP 2023-530514 A nor JP 2018-45952 A discloses any means for suppressing such misalignment.

In view of this issue, the present specification provides a technique useful for suppressing such misalignment.

The present specification discloses a secondary battery. The secondary battery includes an electrode stack in which a plurality of electrodes, each including an electrode active material layer coated on at least one surface of a current collector in the form of a sheet, is stacked in a first direction with a separator interposed between the electrodes. Each of the electrodes includes a current collecting tab that is not coated with the electrode active material layer and that protrudes in a second direction intersecting the first direction. The current collecting tab includes an insulating layer on a surface facing the first direction. The insulating layer includes a protrusion that protrudes toward the separator. The thickness of the insulating layer including the protrusion is smaller than the thickness of the electrode active material layer.

With this configuration, the protrusion of the insulating layer formed on the current collecting tab engages with, or penetrates into, the separator. This suppresses the above-mentioned misalignment.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a secondary battery;

FIG. 2 is an exploded perspective view of an electrode stack;

FIG. 3 is a sectional view showing a portion of an electrode stack including a cathode current collecting tab;

FIG. 4 shows a cathode current collecting tab and its surrounding region, as viewed from a direction parallel to the Z-axis; and

FIG. 5 is a sectional view showing a portion of an electrode stack including a cathode current collecting tab, illustrating an example different from that of FIG. 3.

### DETAILED DESCRIPTION OF EMBODIMENTS

The main features of an embodiment described below will first be described. These features may be combined as desired.

In the secondary battery disclosed in the present specification, the protrusion may be provided at an end of the insulating layer on the side away from the electrode active material layer in the second direction.

With this configuration, the misalignment can be suppressed by utilizing the protrusion formed at the end of the insulating layer when the insulating layer is formed on the current collecting tab.

In the secondary battery disclosed in the present specification, the protrusion may be provided continuously across the width of the current collecting tab, the width extending in a direction intersecting the first direction and the second direction. With this configuration, engagement of the protrusion with the separator is further enhanced, thereby further suppressing the misalignment.

In the secondary battery disclosed in the present specification, the protrusion may be shaped such that the protrusion tapers toward a distal end of the protrusion. With this configuration, the protrusion more readily penetrates into the separator, thereby further suppressing the misalignment.

In the secondary battery disclosed in the present specification, the electrode stack may be a stack in which a cathode and an anode are alternately stacked in the first direction with the separator interposed between the cathode and the anode, the cathode and the anode being the electrodes. The cathode may include a cathode current collecting tab as the current collecting tab, the anode may include an anode current collecting tab as the current collecting tab, and the cathode current collecting tab may include the insulating layer. The cathode current collecting tab may include the insulating layer. With this configuration, the insulating layer provided on the cathode current collecting tab can suppress short-circuiting between the cathode current collecting tab and the anode via foreign matter etc.

An embodiment will now be described with reference to the drawings. The drawings are merely illustrative, and the embodiment is not limited to what is shown in the drawings. Since the drawings are illustrative, certain portions may be omitted for clarity.

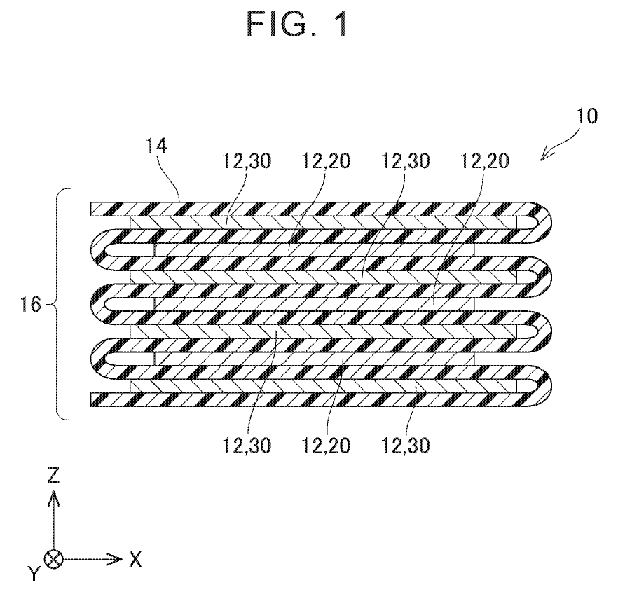

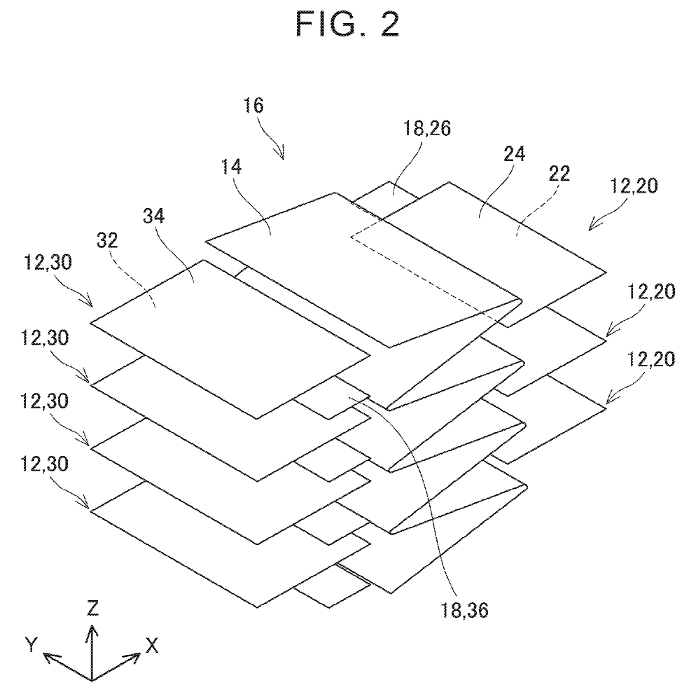

FIG. 1 schematically shows a cross section of a secondary battery 10. The secondary battery 10 may be, for example, a rechargeable lithium-ion battery. The secondary battery 10 includes an electrode stack 16 formed by stacking electrodes 12 in a first direction with separators 14 interposed therebetween. FIG. 2 is a schematic exploded perspective view of the electrode stack 16. The electrodes 12 include a cathode 20 and an anode 30.

The secondary battery 10 includes a flexible outer casing (not shown), and the electrode stack 16 is sealed inside the outer casing. An electrolyte solution (not shown) is also contained inside the outer casing. The outer casing may be, for example, a laminate sheet. For convenience of description, X-, Y-, and Z-axes that are perpendicular to each other are shown in the figures. The Z-axis direction (the +Z- and −Z-directions) corresponds to the first direction. The first direction may also be referred to as "stacking direction." FIG. 1 is a sectional view taken along a plane perpendicular to the Y-axis.

As shown in FIGS. 1 and 2, the electrode stack 16 is formed, for example, by alternately stacking substantially rectangular cathodes 20 and substantially rectangular anodes 30 such that a strip-shaped separator 14 folded in an accordion manner with alternating mountain and valley folds is interposed therebetween. In this configuration, each of the cathodes 20 is sandwiched between two surfaces on one side of the folded separator 14, while each of the anodes 30 is sandwiched between two surfaces on the other side of the folded separator 14. Each of the cathode 20 and the anode 30 extends in the X-axis and Y-axis directions.

The separator 14 is formed of a material that provides both permeability that allows movement of charge carriers (in this case, lithium ions) during charging and discharging, and insulation that suppresses short-circuits caused by contact between the cathode 20 and the anode 30. Examples of materials for the separator 14 include polypropylene and polyethylene. The configuration in which a continuous separator 14 folded in an accordion manner is interposed between the electrodes 12 as shown in FIGS. 1 and 2 is merely an example. The separators 14 interposed between the electrodes 12 may be provided as separate sheets. In any case, the electrode stack 16 is formed by alternately stacking the cathodes 20 and the anodes 30 in the first direction with the separator 14 interposed therebetween.

Each electrode 12 includes a current collector in the form of a sheet and an electrode active material layer coated on at least one surface of the current collector. As shown in FIG. 2, the cathode 20 includes a cathode current collector 22 and a cathode active material layer 24 coated on the cathode current collector 22. The cathode active material layer 24 is coated, for example, on both surfaces of the cathode current collector 22. The cathode current collector 22 is, for example, an aluminum foil. The cathode active material layer 24 contains a cathode active material. Examples of cathode active materials include lithium nickel composite oxides, lithium cobalt composite oxides, and lithium manganese composite oxides.

The anode 30 includes an anode current collector 32 and an anode active material layer 34 coated on the anode current collector 32. The anode active material layer 34 is coated on, for example, both surfaces of the anode current collector 32. The anode current collector 32 is, for example, a copper foil. The anode active material layer 34 contains an anode active material. Examples of anode active materials include carbon materials such as graphite, hard carbon, and soft carbon; materials such as silicon (Si) that form alloys with lithium; and lithium alloys. The electrode active material may be formed of a single material or may be formed of multiple materials. The electrode active material layer may also contain a conductive additive, a binder, etc.

In each electrode 12 (cathode 20 or anode 30), the region of the current collector on which the electrode active material layer (cathode active material layer 24 or anode active material layer 34) is coated is referred to as "coated portion," and the region of the current collector on which no electrode active material layer is coated is referred to as "uncoated portion." Each electrode 12 includes a current collecting tab 18 protruding in a second direction intersecting the first direction. The Y-axis direction (+Y-direction and negative −Y-direction) is an example of the second direction.

As shown in FIG. 2, the uncoated portion of the cathode current collector 22 protrudes in the +Y-direction. This protruding uncoated portion is the current collecting tab 18 of the cathode 20, namely a cathode current collecting tab 26. As shown in FIG. 2, the uncoated portion of the anode current collector 32 protrudes in the −Y-direction. This protruding uncoated portion is the current collecting tab 18 of the anode 30, namely an anode current collecting tab 36. The cathode current collecting tab 26 and the anode current collecting tab 36 protrude in opposite directions and extend outward beyond the region sandwiched between the separators 14.

The cathode current collecting tab 26 may be an extended portion of the cathode current collector 22, or may be a tab-shaped metal foil joined to the uncoated portion of the cathode current collector 22 by, for example, welding. Similarly, the anode current collecting tab 36 may be an extended portion of the anode current collector 32, or may be a tab-shaped metal foil joined to the uncoated portion of the anode current collector 32 by, for example, welding. The respective cathode current collecting tabs 26 of the cathodes 20 are electrically connected to a cathode terminal (not shown). The respective anode current collecting tabs 36 of the anodes 30 are electrically connected to an anode terminal (not shown).

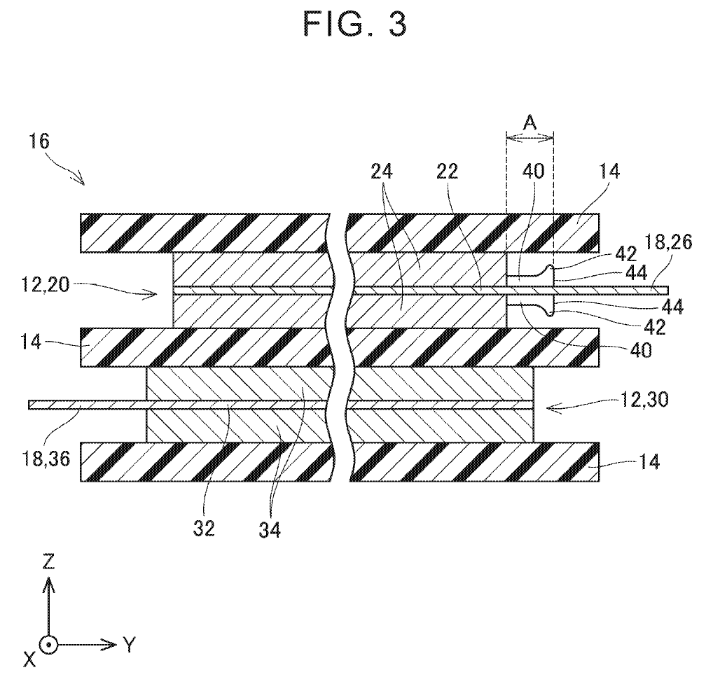

FIG. 3 shows a cross section of a portion of the electrode stack 16 including the cathode current collecting tab 26, taken along a plane perpendicular to the X-axis. The cathode active material layer 24 is formed on both surfaces of the cathode current collector 22. The cathode active material layers 24 are in contact with the separator 14. The anode active material layer 34 is formed on both surfaces of the anode current collector 32. The anode active material layers 34 are in contact with the separator 14. The current collecting tab 18 has an insulating layer 40 on its surface facing the first direction. For clarity, hatching indicating the cross section of the insulating layer 40 is omitted in FIG. 3. As shown in FIG. 3, the insulating layer 40 is formed on both surfaces of the cathode current collecting tab 26, namely on the surfaces of the cathode current collecting tab 26 facing the +Z-direction and the −Z-direction. The insulating layer 40 is formed of an insulating material such as resin. The insulating layer 40 is formed by coating an insulating material onto the current collecting tab 18 after, or in parallel with, the step of coating the electrode active material layer onto the current collector. The insulating layer 40 is in contact with the side surface of the cathode active material layer 24 (in FIG. 3, the side surface facing the +Y-direction), and there is no gap between the insulating layer 40 and the cathode active material layer 24.

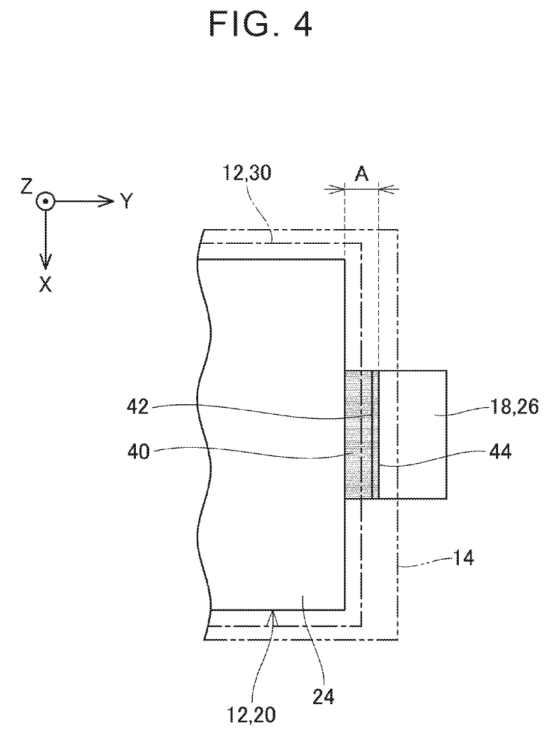

FIG. 4 shows the cathode current collecting tab 26 and its surrounding region, as viewed from a direction parallel to the Z-axis. In FIG. 4, the separator 14 stacked together with the electrodes 12 (the cathode 20 and the anode 30) is shown by a long dashed double-short dashed line, the anode 30 is shown by a long dashed short dashed line, and the cathode 20 is shown by a continuous line. In FIG. 4, the insulating layer 40 is shaded for better understanding. As shown in FIGS. 3 and 4, the formation range A of the insulating layer 40 for the cathode current collecting tab 26 in the Y-axis direction is within the region overlapping the separator 14. In other words, the insulating layer 40 is not formed on the portion of the cathode current collecting tab 26 that protrudes outward beyond the separator 14. As shown in FIG. 4, the insulating layer 40 for the cathode current collecting tab 26 is formed along the entire length of the cathode current collecting tab 26 in the width direction of the cathode current collecting tab 26, that is, in the X-axis direction.

The insulating layer 40 includes a protrusion 42 that protrudes toward the separator 14. The thickness of the insulating layer 40 including the protrusion 42 is smaller than the thickness of the electrode active material layer (in FIG. 3, the cathode active material layer 24). In the present embodiment, the thickness refers to the thickness in the Z-axis direction. For example, when the thickness of the cathode active material layer 24 is 50 μm to 60 μm on one surface of the cathode current collector 22, the thickness of the insulating layer 40 including the protrusion 42 is 8 μm to 10 μm, and the thickness of the insulating layer 40 excluding the protrusion 42 is approximately 4 μm.

As shown in FIGS. 3 and 4, the protrusion 42 of the insulating layer 40 is formed at an end 44 of the insulating layer 40 on the side away from the electrode active material layer (cathode active material layer 24) in the second direction (the Y-axis direction). Furthermore, as shown in FIG. 4, the protrusion 42 is formed continuously across the width of the cathode current collecting tab 26 (in the X-axis direction).

In the state shown in FIG. 3, the distal end of the protrusion 42 is spaced apart from the separator 14. However, the separator 14 and the current collectors have flexibility. Therefore, when the electrodes 12 and the separator 14 are alternately stacked to form the electrode stack 16, the insulating layer 40 and the portion of the separator 14 facing the insulating layer 40 move toward each other, or one moves toward the other. The distal end of the protrusion 42 can therefore come into contact with the separator 14. Accordingly, in the present embodiment, the protrusion 42 of the insulating layer 40 formed on the current collecting tab 18 engages with, or penetrates into, the separator 14. This suppresses relative misalignment between the separator 14 and the electrodes 12. As a result, misalignment between the electrodes 12, that is, between the cathode 20 and the anode 30, is also suppressed, thereby improving the performance of the secondary battery 10.

Since the thickness of the insulating layer 40 including the protrusion 42 is smaller than the thickness of the electrode active material layer, contact between the electrode active material layer and the separator 14 is not hindered by the protrusion 42.

When the insulating layer 40 is formed on the current collecting tab 18 by applying an insulating material, a raised portion of the insulating layer 40 is formed at the end 44 of the insulating layer 40 due to surface tension of the material, and this raised portion forms the protrusion 42. Accordingly, the present specification includes the idea of suppressing misalignment between the separator 14 and the electrodes 12 by utilizing the protrusion 42 that is formed at the end 44 when the insulating layer 40 is formed.

As shown in FIG. 3, the protrusion 42 may have a shape that tapers toward its distal end. By forming the protrusion 42 in a shape that becomes narrower toward its distal end, the protrusion 42 more readily penetrates into the separator 14, thereby further suppressing the above-described misalignment.

As shown in FIGS. 3 and 4, the formation range A of the insulating layer 40 for the cathode current collecting tab 26 in the Y-axis direction extends outward beyond the anode 30. As shown in FIGS. 1, 3, and 4, the size of the cathode 20 excluding the cathode current collecting tab 26 is smaller, in both the X-axis and Y-axis directions, than the size of the anode 30 excluding the anode current collecting tab 36. As can be seen from FIGS. 2 and 3, the anode current collecting tab 36 protrudes from the end of the anode 30 facing the −Y-direction, whereas the cathode current collecting tab 26 protrudes from the end of the cathode 20 facing the +Y-direction. In this configuration, the formation range A of the insulating layer 40 extends outward beyond the end of the anode 30 facing the +Y-direction. Accordingly, the end 44 of the insulating layer 40 and the protrusion 42 are located outward of the end of the anode 30 facing the +Y-direction. By forming the insulating layer 40 on the cathode current collecting tab 26, short-circuiting between the cathode current collecting tab 26 and the anode 30 via foreign matter etc. can be suppressed.

The configuration of the protrusion 42 of the insulating layer 40 is not limited to the above example. For example, the protrusion 42 may be formed at a position other than the end 44 on the insulating layer 40. The protrusion 42 may be formed at multiple positions on the insulating layer 40. For example, the protrusions 42 may be formed intermittently in the width direction of the cathode current collecting tab 26 (the X-axis direction).

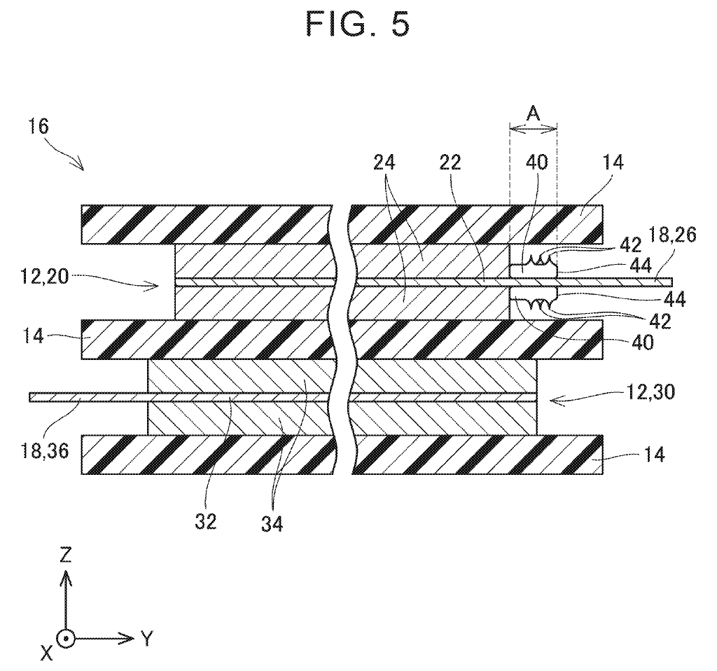

FIG. 5 shows a cross section of a portion of the electrode stack 16 including the cathode current collecting tab 26, taken along a plane perpendicular to the X-axis as in FIG. 3. Description common to FIG. 3 is omitted for FIG. 5. As shown in FIG. 5, the insulating layer 40 includes multiple protrusions 42 that protrude toward the separator 14. The protrusions 42 are spaced apart from each other in the X-axis direction and/or the Y-axis direction. In the step of forming the insulating layer 40 on the current collecting tab 18, for example, multiple spike-like protrusions 42 can be formed by roughening the surface of the insulating layer 40 to make the surface uneven.

In the present embodiment, the insulating layer 40 including the protrusions 42 may be formed on the cathode current collecting tab 26 out of the cathode current collecting tab 26 and the anode current collecting tab 36. Alternatively, the insulating layer 40 including the protrusions 42 may be formed on each of the cathode current collecting tab 26 and the anode current collecting tab 36. The above description of the insulating layer 40 and protrusions 42 formed on the cathode current collecting tab 26 also applies to the insulating layer 40 and protrusions 42 formed on the anode current collecting tab 36.

Although specific examples of the technology disclosed in the present specification have been described in detail above, these examples are merely illustrative and do not limit the scope of the claims. The technology described in the claims includes various modifications and variations of the specific examples illustrated above. The technical elements described in the present specification and the drawings exhibit technical utility either individually or in various combinations, and are not limited to the combinations described in the claims as originally filed. The technology illustrated in the present specification and the drawings achieve multiple objectives simultaneously, and achieving even one of these objectives alone provides technical utility.

What is claimed is:

1. A secondary battery comprising an electrode stack in which a plurality of electrodes, each including an electrode active material layer coated on at least one surface of a current collector in a form of a sheet, is stacked in a first direction with a separator interposed between the electrodes, wherein:
each of the electrodes includes a current collecting tab that is not coated with the electrode active material layer and that protrudes in a second direction intersecting the first direction;
the current collecting tab includes an insulating layer on a surface facing the first direction;
the insulating layer includes a protrusion that protrudes toward the separator; and
a thickness of the insulating layer including the protrusion is smaller than a thickness of the electrode active material layer.

2. The secondary battery according to claim 1, wherein the protrusion is provided at an end of the insulating layer on a side away from the electrode active material layer in the second direction.

3. The secondary battery according to claim 2, wherein the protrusion is provided continuously across a width of the current collecting tab, the width extending in a direction intersecting the first direction and the second direction.

4. The secondary battery according to claim 1, wherein the protrusion is shaped such that the protrusion tapers toward a distal end of the protrusion.

5. The secondary battery according to claim 1, wherein:
the electrode stack is a stack in which a cathode and an anode are alternately stacked in the first direction with the separator interposed between the cathode and the anode, the cathode and the anode being the electrodes;
the cathode includes a cathode current collecting tab as the current collecting tab;
the anode includes an anode current collecting tab as the current collecting tab; and
the cathode current collecting tab includes the insulating layer.
